(19) United States
(12) Patent Application Publication
(10) Pub. No.: US 2025/0165848 A1
(43) Pub. Date: May 22, 2025

(54) SYSTEMS AND METHODS FOR ITERATIVE FEATURE SELECTION FOR MACHINE LEARNING MODELS

(71) Applicant: Capital One Services, LLC, McLean, VA (US)

(72) Inventors: Daniel GUNN, Toronto (CA); Joseph GALLAGHER, Toronto (CA); Dike ADULUSO-NWAOBASI, Toronto (CA); Chengran OUYANG, Toronto (CA); Varun CHADHARI, Toronto (CA)

(73) Assignee: Capital One Services, LLC, McLean, VA (US)

(21) Appl. No.: 18/510,893

(22) Filed: Nov. 16, 2023

(51) Int. Cl. G06N 20/00

(52) U.S. Cl. CPC G06N 20/00

(57) ABSTRACT

Systems and methods for selecting machine learning features using iterative batch feature reduction. In some aspects, the system trains a plurality of candidate models based on a plurality of feature groups split from a first set of features. Each candidate model takes as input a feature group of no more than a first threshold number of features. For each candidate model in the plurality of candidate models, the system processes the candidate model to extract an explainability vector. Based on the explainability vector, the system selects a second threshold number of features from the feature group to generate a slim feature group. The system trains a slim candidate model which takes as input the slim feature group. The system generates a second set of features by combining features from a plurality of slim candidate models.

### SUMMARY

Methods and systems are described herein for novel uses and/or improvements to artificial intelligence applications. As one example, methods and systems are described herein for selecting machine learning features using iterative batch feature reduction. For example, methods and systems may generate a lightweight model from a full machine learning model using iterative feature selection. The lightweight or surrogate model may be generated using an alternate set of features (e.g., subset or combination of features or a variation thereof) determined using explainability vectors from candidate models each trained on a portion of the full feature set. The system may iteratively remove features from candidate models using ranking in its corresponding explainability vector.

Conventional systems have not contemplated leveraging an explainability vector for feature selection and/or recombination of a set of features for a machine learning model. Adapting explainability vectors and artificial intelligence models for this practical benefit faces several technical challenges such as the difficulty of determining the importance of each feature to generating a model's output and the high computation costs of training models with full feature sets. To overcome these technical deficiencies in adapting artificial intelligence models for this practical benefit, methods and systems disclosed herein divide a full set of features into feature groups. In some aspects, a candidate model is trained for each feature group. An explainability vector is generated for each candidate model. Using its explainability vector, a candidate model is updated to contain the most impactful features. The process may repeat until the candidate models hit a performance metric, when the system extracts a second set of features. In some embodiments, a final candidate model is trained using the second set of features as input, and a final explainability vector corresponding to the final candidate model is used to generate a final set of features. Thus, methods and systems disclosed herein make use of explainability vectors to generate an improved set of features in a computationally expedient manner.

In some aspects, methods and systems are described herein comprising: training a plurality of candidate models based on a plurality of feature groups split from a first set of features, wherein each candidate model in the plurality of candidate models takes as input a feature group from the plurality of feature groups, wherein each feature group includes no more than a first threshold number of features; for each candidate model in the plurality of candidate models: processing the candidate model to extract an explainability vector, wherein each entry in the explainability vector corresponds to a feature in the feature group associated with the candidate model and is indicative of a correlation between the feature and output of the candidate model; based on the explainability vector, selecting a second threshold number of features from the feature group to generate a slim feature group; training a slim candidate model, wherein the slim candidate model takes as input the slim feature group; generating a second set of features by combining features from a plurality of slim candidate models corresponding to the plurality of candidate models; training a final candidate model which takes as input the second set of features; processing the final candidate model to extract a final explainability vector; based on the final explainability vector, selecting a third threshold number of features from the second set of features to generate a final set of features; and training a final machine learning model which takes as input the final set of features.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for iterative feature selection using explainability vectors, in accordance with one or more embodiments.

FIG. 2 show an illustration of a first set of features being reduced to a second set of features, in accordance with one or more embodiments.

FIG. 3 shows illustrative components for a system for iterative feature selection using explainability vectors, in accordance with one or more embodiments.

FIG. 4 shows a flowchart of the steps involved in iterative feature selection using explainability vectors, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

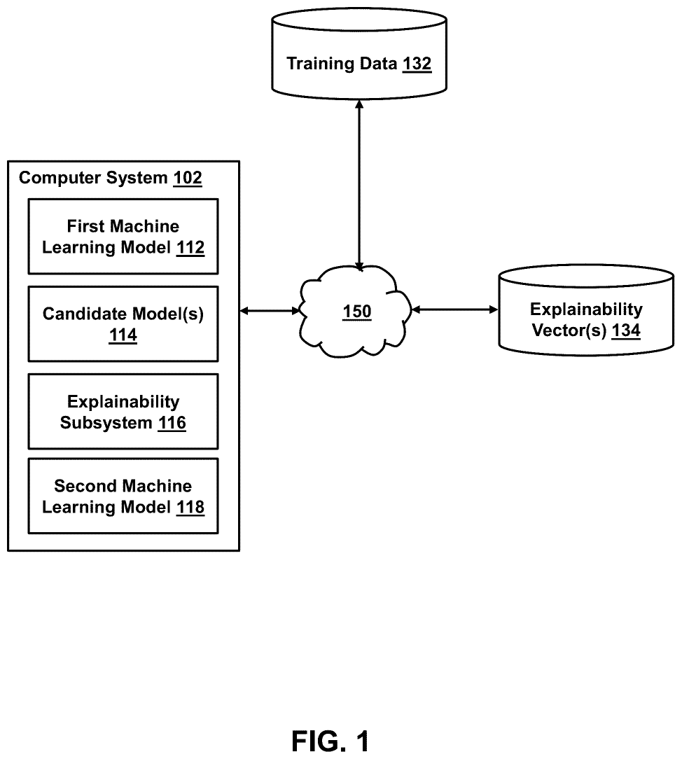

FIG. 1 shows an illustrative diagram for system 150, which contains hardware and software components used to train resource consumption machine learning models, extract explainability vectors and perform feature engineering, in accordance with one or more embodiments. For example, Computer System 102, a part of system 150, may include First Machine Learning Model 112, Candidate Model(s) 114, Explainability Subsystem 116, and Second Machine Learning Model 118.

System 150 (the system) may receive Training Data 132. Training Data 132 may contain a first set of features, which may be used as input by a machine learning model (e.g., First Machine Learning Model 112). Training Data 132 may, for example, include a plurality of user profiles relating to resource consumption for a plurality of user systems. The first set of features may contain categorical or quantitative variables, and values for such features may describe, for example, a length of time for which the user system has recorded resource consumption, an extent and frequency of resource consumption, and the number of instances of the user system's excessive resource consumption. Each user profile may correspond to a resource consumption value indicating the current consumption of resources by the user system, which may also be recorded in Training Data 132 in association with the user profile. The system may retrieve a plurality of user profiles as a matrix including vectors of feature values for the first set of features and append to the end of each vector a resource consumption value.

In some embodiments, the system may, before retrieving user profiles, process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may train a first machine learning model (e.g., First Machine Learning Model 112) based on a matrix representing the plurality of user profiles. First Machine Learning Model 112 may take as input a vector of feature values for the entirety of first set of features and output a resource consumption score indicating an amount of resources used by a user system with such feature values as the input. First Machine Learning Model 112 may use one or more algorithms like linear regression, generalized additive models, artificial neural networks or random forests to achieve quantitative prediction. The system may partition the matrix of user profiles into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights, each weight in which is a real number. The repeated multiplication and combination of weights transform input values to First Machine Learning Model 112 into output values. The system may measure the performance of First Machine Learning Model 112 using a method such as cross-validation to generate a quantitative representation, e.g., a first performance metric.

In some embodiments, the first set of features may be so numerous or cumbersome that the system may choose to select a subset of the most relevant features from the first set of features. To do so, the system may adopt a process of splitting the first set of features into feature groups. Each feature group may be trimmed by, for example, training a candidate model using the feature group and selecting features of high relevance to the candidate model. The system may split the first set of features into disparate feature groups by, for example, randomly assigning each feature to one of the feature groups. In some embodiments, each feature group may be at most a predetermined size, e.g., 1000 features. The system may then train a plurality of candidate models (e.g., Candidate Model(s) 114), each of which use a feature group as input. Each of the candidate models may use the same algorithms and generate the same types of output as First Machine Learning Model 112. The training process may similarly be identical for First Machine Learning Model 112 and each of the candidate models. In some embodiments, each of the candidate models in Candidate Model(s) 114 may be trained on the full training dataset. In other embodiments, each of the candidate models in Candidate Model(s) 114 may be trained on a random sample of the training dataset. Though the candidate models use different inputs from First Machine Learning Model 112, due to the nature of outputs being the same type between the models, each of the candidate models may be associated with a candidate performance score. A candidate performance score may be calculated on the same method as the first performance metric.

For each candidate model in Candidate Model(s) 114, the system may employ an iterative process to select the most impactful features in the feature group associated with the candidate model. The system may process the candidate model to extract an explainability vector(s) (e.g., Explainability Vector(s) 134), for example using Explainability Subsystem 116. Explainability Subsystem 116 may employ a variety of explainability techniques depending on the algorithms in Candidate Model(s) 114 to extract Explainability Vector(s) 134. Explainability Vector(s) 134 contains one entry for each feature in the set of features in the input to the candidate model being processed, and the entry reflects the importance of that feature to the model. The values within Explainability Vector(s) 134 additionally represent how each features correlates to the output of the model, and the causative effect of each feature in producing the output as construed by the model. In some embodiments, a correlation matrix may be attached to Explainability Vector(s) 134. The correlation matrix captures how variables are correlated with other variables. This is relevant because correlation between variables in a model causes interference in their causative effects in producing the output of the model.

Below are some examples of how Explainability Subsystem 116 extracts an explainability vector in Explainability Vector(s) 134 from each candidate model.

For example, the candidate model may contain a matrix of weights for a multivariate regression algorithm. Explainability Subsystem 116 may use a Shapley Additive Explanation method to extract Explainability Vector(s) 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector(s) 134 may be a list of normalized Shapley values of each feature.

In another example, the candidate model may contain a vector(s) of coefficients for a generalized additive model. Since the nature of generalized additive models is such that the effect of each variable on the output is completely and independently captured by its coefficient, Explainability Subsystem 116 may take the list of coefficients to be Explainability Vector(s) 134.

In another example, the candidate model may contain a matrix of weights for a supervised classifier algorithm. Explainability Subsystem 116 may use a Local Interpretable Model-agnostic Explanations method to extract Explainability Vector(s) 134. The Local Interpretable Model-agnostic Explanations approximates the results of the candidate model with an explainable model, e.g., a decision tree classifier. The approximate model is trained using a loss heuristic that judges similarity to the candidate model and that penalizes complexity. In some embodiments, the number of variables that the approximate model uses can be specified. The approximate model will clearly define the effect of each feature on the output: for example, the approximate model may be a generalized additive model.

In another example, the candidate model may contain a matrix of weights for a convolutional neural network algorithm. Explainability Subsystem 116 may use a Gradient Class Activation Mapping method to extract Explainability Vector(s) 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector(s) 134 may be a list of such derivatives.

In another example, the candidate model may contain a set of parameters comprising a hyperplane matrix for a support vector(s) machine algorithm. Explainability Subsystem 116 may use a counterfactual explanation method to extract Explainability Vector(s) 134. The counterfactual explanation method looks for input data which are identical or extremely close in values for all features except one. Then the difference in prediction results may divided by the difference in the divergent value. This process is repeated on each feature for all pairs of available input vector(s) s, and the aggregated result is a measure for the effect of each feature on the output of the model, which may be formed into Explainability Vector(s) 134.

Using Explainability Vector(s) 134 corresponding to a candidate model, the system may select a slim feature group from the feature group associated with the candidate model. In some embodiments, the slim feature group may be features satisfying a percentile cutoff based on their values in the explainability vector for the candidate model. For example, the system may select the top ninety percent of features as ranked by values in the explainability vector. In other embodiments, the system may choose a slim feature group by removing a fixed number of lowest-ranking features by values in the explainability vector. For example, the system may remove the bottom 50 features ranked by values in the explainability vector from the feature group to form the slim feature group on the remaining features. In other embodiments, the system may receive a user request specifying that a subset of features be removed from consideration or that impact of the subset of features be reduced. The system may apply a mathematical transformation to the explainability vector such that values corresponding to the subset of features are adjusted or such that the subset of features is removed. For example, the system may receive user profiles representing applicants for credit cards. A feature in the set of features may be the race or ethnicity of the applicant. The user may wish to exclude such features from consideration. In other embodiments, the system may calculate a threshold value for removing features. All features with values the explainability vector below the threshold value may be removed, and remaining features may form the slim feature group.

In some embodiments, the system may iteratively repeat the process of processing a candidate model to extract an explainability vector, generating a slim feature group, and training a slim candidate model based on the slim feature group. For example, the system may train a first-generation candidate model (e.g., a model in Candidate Model(s) 114) based on a feature group taken directly from the first set of features. The first-generation candidate model may be associated with a first candidate performance score. The system may extract a first explainability vector from the first-generation candidate model. Using the first explainability vector, the system may generate a second-generation slim feature group, which is selected from the feature group using one of the above methods. Using the second-generation slim feature group, the system may train a second-generation candidate model, using the same algorithms and training procedures as the first-generation candidate model. The second-generation candidate model may be associated with a second candidate performance score. The system may then extract a second explainability vector from the second-generation candidate model. Using the second explainability vector, the system may generate a third-generation slim feature group, a subset of the second-generation slim feature group. The system may then train a third-generation slim model using the third-generation slim feature group, and the process may recursively continue. The system may halt the iterative repetition of training slim models, extracting explainability vectors and selecting slim feature groups in response to a candidate performance metric associated with a candidate model hits a threshold. For example, the system may compare each candidate performance score against a percentage of the performance score of First Machine Learning Model 112. For example, the first candidate model which performs at 1.2 times the error rate of First Machine Learning Model 112 may be selected as a slim candidate model. In some embodiments, the generation of candidate model just prior to the generation which performs at the threshold may instead be selected.

Using the plurality of slim candidate models, each of which may be selected using the above process, the system may generate a second set of features. The second set of features may include all features used by any of the slim candidate models. The second set of features may be used by a final candidate model as input. By doing so, the final candidate model may consider all the features in the first set of features known to have some importance. The final candidate model may be trained in the same framework as Candidate Model(s) 114. The system may process the final candidate model to extract a final explainability vector. The system may then rank features in the second set of features based on the final explainability vector. The system may thus select a third threshold number of features from the ranked second set of features to generate a final set of features. For example, the final set of features may be the top 100 features in the second set of features, as ranked by values in the final explainability vector.

The system may train a final machine learning model (e.g., Second Machine Learning Model 118) which takes as input the final set of features. Second Machine Learning Model 118 may be trained using the same framework as First Machine Learning Model 112. Second Machine Learning Model 118 may use as input a vector of feature values for the final set of features, which is a subset of the first set of features. Second Machine Learning Model 118 may output, for example, resource consumption scores for user systems. Second Machine Learning Model 118 may use one or more algorithms like linear regression, generalized additive models, artificial neural networks or random forests to achieve quantitative prediction. Second Machine Learning Model 118 may be trained using the gradient descent technique, for example.

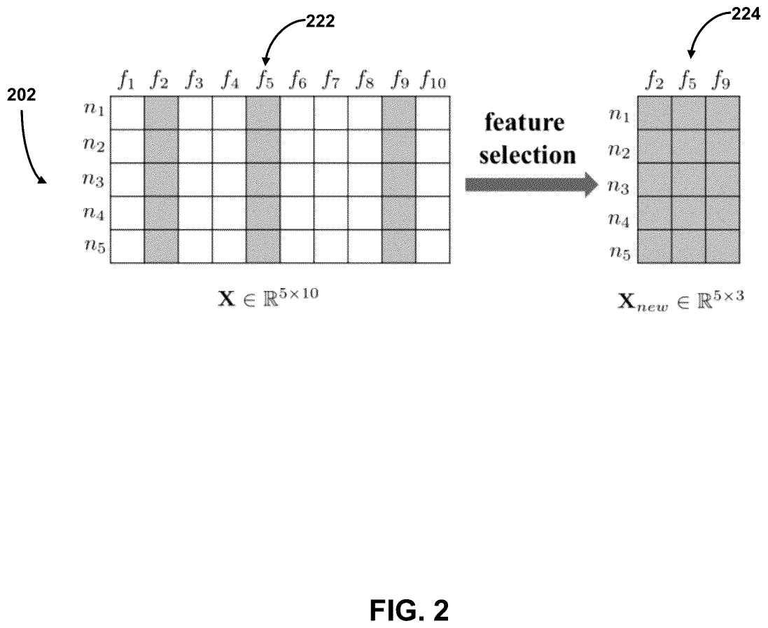

FIG. 2 shows the effects of feature selection, such as the process of generating a slim feature group from an initial feature group. FIG. 2 shows Data Entries 202, which are five data entries initially consisting of a full feature set, Feature Set 222. The system may perform feature selection which generates Feature Set 224 from Feature Set 222. For example, Data Entries 202 may correspond to part of Training Data 132. Training Data 132 may include the full first set of features, for example Feature Set 222. Each data entry in Data Entries 202 may contain a set of values, each value in which represents a feature in Feature Set 222. For example, each data entry in Data Entries 202 may correspond to an independent observation of a process defined by values for Feature Set 222.

The entirety of Feature Set 222 may be used as input in First Machine Learning Model 112. The system may elect to perform feature selection from Feature Set 222 using First Machine Learning Model 112, its corresponding candidate models and associated explainability vectors. For example, the system may initialize feature groups of Feature Set 222, each of which contain 2 features. For example, the features f1 and f2 may be assigned to the same feature group, f3 and f4 may be another feature group. Similar groups may be formed for f5 and f6, for f7 and f8, and f9 and f10. A first-generation candidate model may be trained for each of the feature groups, resulting in a set of five candidate models (Candidate Model(s) 114). For example, one candidate model may take f1 and f2 as input, and another candidate model takes f9 and f10 as input. For example, each of the candidate models may be trained on the entirety of Data Entries 202, but only with reference to their input features. The system may process each candidate model in Candidate Model(s) 114 to extract an explainability vector corresponding to the candidate model. For example, the system may generate an explainability vector corresponding to the candidate model which takes f1 and f2 as input, the explainability vector containing two values. One of the values indicates a correlation between f1 and output of the candidate model, and the other value is the same correlation for f2. Using the explainability vector, the system may, for example, select a feature from between f1 and f2. The system may choose the feature with the highest value. In embodiments where features are more numerous, the system may use a percentile cutoff, for example. In this example, the system may select f2 to be the slim feature group based on the initial feature group due to its higher value in the explainability vector. In embodiments where features are more numerous, the system may use the slim feature groups from each feature group to train a set of next-generation candidate models. The system may then iteratively repeat the process of extracting explainability vectors from the set of next-generation candidate models, forming slim feature groups, and training yet the next generation of candidate models. The iterative repetition may stop when, for example, a candidate model performs at a certain threshold percentage of the performance of First Machine Learning Model 112. The system may then generate a second set of features by combining all features from the plurality of slim candidate models in that generation. In the above example, the system may for example select f2, f3, f5, f8, and f9 to be the second set of features because each of them had a higher value in their respective explainability vectors. The system may then train a final candidate model using the second set of features. The final candidate model may once again be trained using the same framework and data as First Machine Learning Model 112, but only taking the second set of features as input.

Using the final candidate model, the system may generate a final explainability vector, each value in which corresponds to a feature in the second feature set and is indicative of a correlation between the feature and output of the final candidate model. Using the final explainability vector, the system may select a third set of features (e.g., Feature Set 224) from the second set of features. For example, the system may rank the second set of features by their values in the final explainability vector. In the above example, the second set of features may be ranked as f5, f9, f2, f3, and f8. The system may select Feature Set 224 using a cutoff percentile of the second set of features, for example. In the above example, the system may select the top three features from the second set of features. In some embodiments, the system may use Feature Set 224 to train a final machine learning model. The final machine learning makes use of the most salient features from Feature Set 222, and is therefore a lightweight alternative to First Machine Learning Model 112 while retaining as much performance as possible.

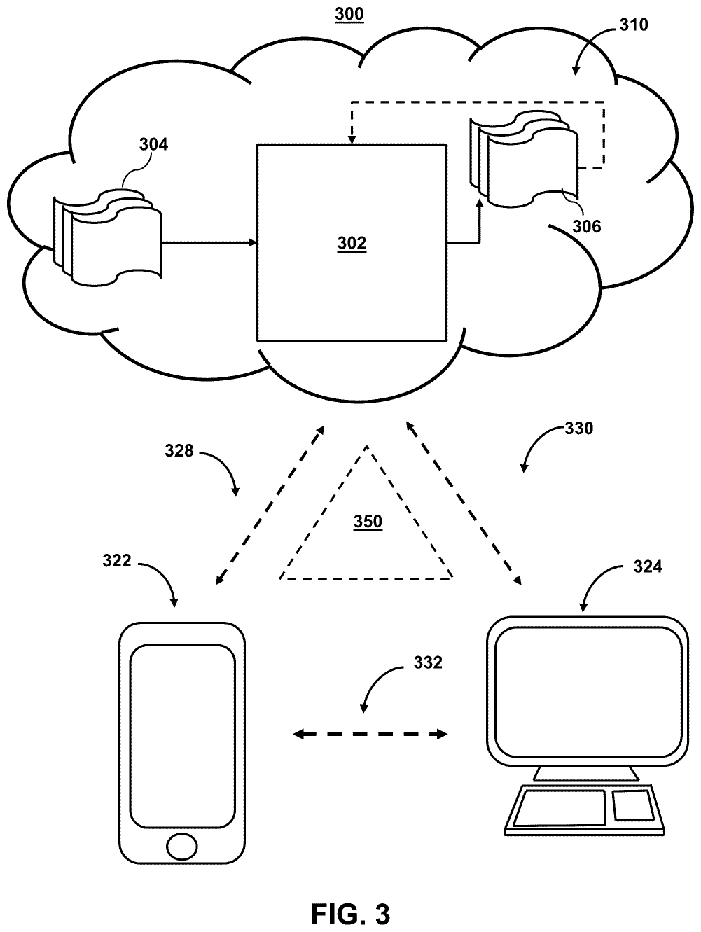

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

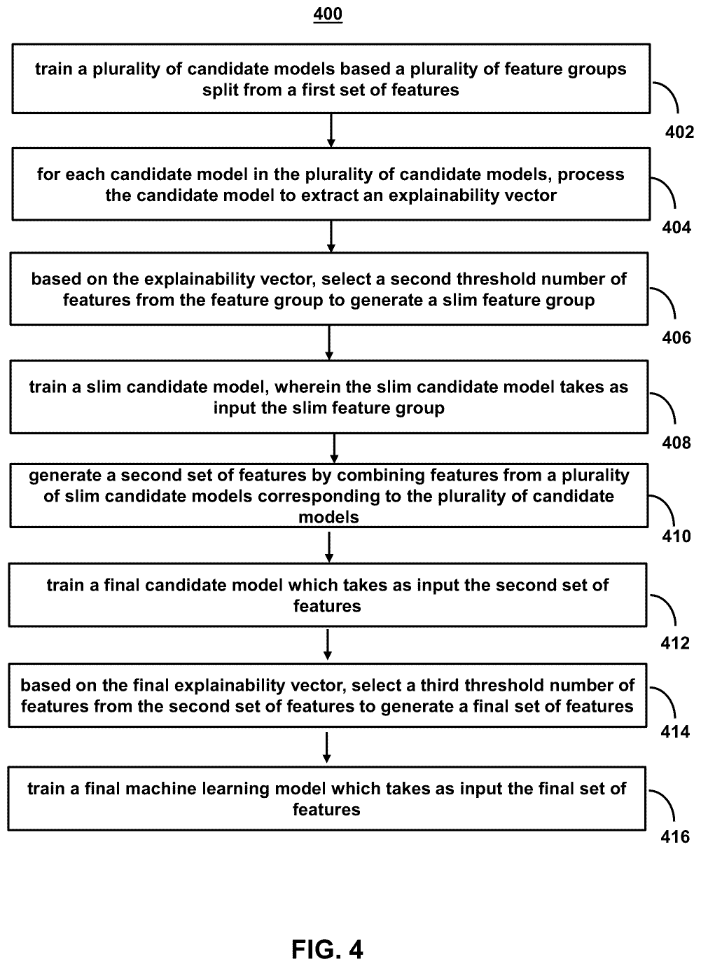

FIG. 4 shows a flowchart of the steps involved in generate recommendations for reducing resource consumption, in accordance with one or more embodiments. For example, the system may use process 400 (e.g., as implemented on one or more system components described above) in order to collect and process data about users, train Machine Learning Models, extract explainability vectors, and select and recombine features.

At step 402, process 400 (e.g., using one or more components described above) may train a plurality of candidate models based a plurality of feature groups split from a first set of features. System 150 (the system) may receive Training Data 132. Training Data 132 may contain a first set of features, which may be used as input by a machine learning model (e.g., First Machine Learning Model 112). Training Data 132 may, for example, include a plurality of user profiles relating to resource consumption for a plurality of user systems. The first set of features may contain categorical or quantitative variables, and values for such features may describe, for example, a length of time for which the user system has recorded resource consumption, an extent and frequency of resource consumption, and the number of instances of the user system's excessive resource consumption. Each user profile may correspond to a resource consumption value indicating the current consumption of resources by the user system, which may also be recorded in Training Data 132 in association with the user profile. The system may retrieve a plurality of user profiles as a matrix including vectors of feature values for the first set of features and append to the end of each vector a resource consumption value.

In some embodiments, the system may, before retrieving user profiles, process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may train a first machine learning model (e.g., First Machine Learning Model 112) based on a matrix representing the plurality of user profiles. First Machine Learning Model 112 may take as input a vector of feature values for the entirety of first set of features and output a resource consumption score indicating an amount of resources used by a user system with such feature values as the input. First Machine Learning Model 112 may use one or more algorithms like linear regression, generalized additive models, artificial neural networks or random forests to achieve quantitative prediction. The system may partition the matrix of user profiles into a training set and a cross-validating set. Using the training set, the system may train First Machine Learning Model 112 using, for example, the gradient descent technique. The system may then cross-validate the trained model using the cross-validating set and further fine-tune the parameters of the model. First Machine Learning Model 112 may include one or more parameters that it uses to translate input into outputs. For example, an artificial neural network contains a matrix of weights, each weight in which is a real number. The repeated multiplication and combination of weights transform input values to First Machine Learning Model 112 into output values. The system may measure the performance of First Machine Learning Model 112 using a method such as cross-validation to generate a quantitative representation, e.g., a first performance metric.

In some embodiments, the system may choose to select a subset of the most relevant features from the first set of features. To do so, the system may adopt a process of splitting the first set of features into feature groups. Each feature group may be trimmed by, for example, training a candidate model using the feature group and selecting features of high relevance to the candidate model. The system may split the first set of features into disparate feature groups by, for example, randomly assigning each feature to one of the feature groups. In some embodiments, each feature group may be at most a predetermined size, e.g., 1000 features. The system may then train a plurality of candidate models (e.g., Candidate Model(s) 114), each of which use a feature group as input. Each of the candidate models may use the same algorithms and generate the same types of output as First Machine Learning Model 112. The training process may similarly be identical for First Machine Learning Model 112 and each of the candidate models. In some embodiments, each of the candidate models in Candidate Model(s) 114 may be trained on the full training dataset. In other embodiments, each of the candidate models in Candidate Model(s) 114 may be trained on a random sample of the training dataset. Though the candidate models use different inputs from First Machine Learning Model 112, due to the nature of outputs being the same type between the models, each of the candidate models may be associated with a candidate performance score. A candidate performance score may be calculated on the same method as the first performance metric.

At step 404, process 400 (e.g., using one or more components described above) may process the candidate model to extract an explainability vector for each candidate model in the plurality of candidate models. The system may process the candidate model to extract an explainability vector(s) (e.g., Explainability Vector(s) 134), for example using Explainability Subsystem 116. Explainability Subsystem 116 may employ a variety of explainability techniques depending on the algorithms in Candidate Model(s) 114 to extract Explainability Vector(s) 134. Explainability Vector(s) 134 contains one entry for each feature in the set of features in the input to the candidate model being processed, and the entry reflects the importance of that feature to the model. The values within Explainability Vector(s) 134 additionally represent how each features correlates to the output of the model, and the causative effect of each feature in producing the output as construed by the model. In some embodiments, a correlation matrix may be attached to Explainability Vector(s) 134. The correlation matrix captures how variables are correlated with other variables. This is relevant because correlation between variables in a model causes interference in their causative effects in producing the output of the model.

Below are some examples of how Explainability Subsystem 116 extracts an explainability vector in Explainability Vector(s) 134 from each candidate model.

For example, the candidate model may contain a matrix of weights for a multivariate regression algorithm. Explainability Subsystem 116 may use a Shapley Additive Explanation method to extract Explainability Vector(s) 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector(s) 134 may be a list of normalized Shapley values of each feature.

In another example, the candidate model may contain a vector(s) of coefficients for a generalized additive model. Since the nature of generalized additive models is such that the effect of each variable on the output is completely and independently captured by its coefficient, Explainability Subsystem 116 may take the list of coefficients to be Explainability Vector(s) 134.

In another example, the candidate model may contain a matrix of weights for a supervised classifier algorithm. Explainability Subsystem 116 may use a Local Interpretable Model-agnostic Explanations method to extract Explainability Vector(s) 134. The Local Interpretable Model-agnostic Explanations approximates the results of the candidate model with an explainable model, e.g., a decision tree classifier. The approximate model is trained using a loss heuristic that judges similarity to the candidate model and that penalizes complexity. In some embodiments, the number of variables that the approximate model uses can be specified. The approximate model will clearly define the effect of each feature on the output: for example, the approximate model may be a generalized additive model.

In another example, the candidate model may contain a matrix of weights for a convolutional neural network algorithm. Explainability Subsystem 116 may use a Gradient Class Activation Mapping method to extract Explainability Vector(s) 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector(s) 134 may be a list of such derivatives.

In another example, the candidate model may contain a set of parameters comprising a hyperplane matrix for a support vector(s) machine algorithm. Explainability Subsystem 116 may use a counterfactual explanation method to extract Explainability Vector(s) 134. The counterfactual explanation method looks for input data which are identical or extremely close in values for all features except one. Then the difference in prediction results may divided by the difference in the divergent value. This process is repeated on each feature for all pairs of available input vector(s) s, and the aggregated result is a measure for the effect of each feature on the output of the model, which may be formed into Explainability Vector(s) 134.

At step 406, process 400 (e.g., using one or more components described above) may, based on the explainability vector, select a second threshold number of features from the feature group to generate a slim feature group. Using Explainability Vector(s) 134 corresponding to a candidate model, the system may select a slim feature group from the feature group associated with the candidate model. In some embodiments, the slim feature group may be features satisfying a percentile cutoff based on their values in the explainability vector for the candidate model. For example, the system may select the top ninety percent of features as ranked by values in the explainability vector. In other embodiments, the system may choose a slim feature group by removing a fixed number of lowest-ranking features by values in the explainability vector. For example, the system may remove the bottom 50 features ranked by values in the explainability vector from the feature group to form the slim feature group on the remaining features. The system may alternatively select the top 50 features ranked by values in the explainability vector from the feature group to form the slim feature group. In other embodiments, the system may receive a user request specifying that a subset of features be removed from consideration or that impact of the subset of features be reduced. The system may apply a mathematical transformation to the explainability vector such that values corresponding to the subset of features are adjusted or such that the subset of features is removed. For example, the system may receive user profiles representing applicants for credit cards. A feature in the set of features may be the race or ethnicity of the applicant. The user may wish to exclude such features from consideration. In other embodiments, the system may calculate a threshold value for removing features. All features with values the explainability vector below the threshold value may be removed, and remaining features may form the slim feature group.

At step 408, process 400 (e.g., using one or more components described above) may train a slim candidate model, wherein the slim candidate model takes as input the slim feature group. In some embodiments, the system may iteratively repeat the process of processing a candidate model to extract an explainability vector, generating a slim feature group, and training a slim candidate model based on the slim feature group. For example, the system may train a first-generation candidate model (e.g., a model in Candidate Model(s) 114) based on a feature group taken directly from the first set of features. The first-generation candidate model may be associated with a first candidate performance score. The system may extract a first explainability vector from the first-generation candidate model. Using the first explainability vector, the system may generate a second-generation slim feature group, which is selected from the feature group using one of the above methods. Using the second-generation slim feature group, the system may train a second-generation candidate model, using the same algorithms and training procedures as the first-generation candidate model. The second-generation candidate model may be associated with a second candidate performance score. The system may then extract a second explainability vector from the second-generation candidate model. Using the second explainability vector, the system may generate a third-generation slim feature group, a subset of the second-generation slim feature group. The system may then train a third-generation slim model using the third-generation slim feature group, and the process may recursively continue. The system may halt the iterative repetition of training slim models, extracting explainability vectors and selecting slim feature groups in response to a candidate performance metric associated with a candidate model hits a threshold. For example, the system may compare each candidate performance score against a percentage of the performance score of First Machine Learning Model 112. For example, the first candidate model which performs at 1.2 times the error rate of First Machine Learning Model 112 may be selected as a slim candidate model. In some embodiments, the generation of candidate model just prior to the generation which performs at the threshold may instead be selected.

At step 410, process 400 (e.g., using one or more components described above) may generate a second set of features by combining features from a plurality of slim candidate models corresponding to the plurality of candidate models. Using the plurality of slim candidate models, each of which may be selected using the process in step 408, the system may generate a second set of features. The second set of features may include all features used by any of the slim candidate models. The second set of features may be used by a final candidate model as input. By doing so, the final candidate model may consider all the features in the first set of features known to have some importance.

At step 412, process 400 (e.g., using one or more components described above) may train a final candidate model which takes as input the second set of features. The final candidate model may be trained in the same framework as Candidate Model(s) 114. The system may process the final candidate model to extract a final explainability vector. The system may then rank features in the second set of features based on the final explainability vector.

At step 414, process 400 (e.g., using one or more components described above) may, based on the final explainability vector, select a third threshold number of features from the second set of features to generate a final set of features. By ranking the second set of features using the final explainability vector, the system may select a third threshold number of features from the ranked second set of features to generate a final set of features. For example, the final set of features may be the top 100 features in the second set of features, as ranked by values in the final explainability vector. Alternatively, the system may select the top 10 percent of features in the second set of features as ranked by values in the final explainability vector.

At step 416, process 400 (e.g., using one or more components described above) may train a final machine learning model which takes as input the final set of features. The system may train a final machine learning model (e.g., Second Machine Learning Model 118) which takes as input the final set of features. Second Machine Learning Model 118 may be trained using the same framework as First Machine Learning Model 112. Second Machine Learning Model 118 may use as input a vector of feature values for the final set of features, which is a subset of the first set of features. Second Machine Learning Model 118 may output, for example, resource consumption scores for user systems. Second Machine Learning Model 118 may use one or more algorithms like linear regression, generalized additive models, artificial neural networks or random forests to achieve quantitative prediction. Second Machine Learning Model 118 may be trained using the gradient descent technique, for example.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a first set of features for use as input in a machine learning model; splitting the first set of features into a plurality of feature groups, wherein each feature group includes no more than a first threshold number of features; training a plurality of candidate models, wherein each candidate model in the plurality of candidate models takes as input a feature group from the plurality of feature groups; for each candidate model in the plurality of candidate models: processing the candidate model to extract an explainability vector, wherein each entry in the explainability vector corresponds to a feature in the feature group associated with the candidate model and is indicative of a correlation between the feature and output of the candidate model; ranking features in the feature group based on the explainability vector; selecting a second threshold number of features from the ranked feature group to generate a slim feature group; training a slim candidate model, wherein the slim candidate model takes as input the slim feature group; generating a second set of features by combining features from a plurality of slim candidate models corresponding to the plurality of candidate models; training a final candidate model which takes as input the second set of features; processing the final candidate model to extract a final explainability vector; ranking features in the second set of features based on the final explainability vector; selecting a third threshold number of features from the ranked second set of features to generate a final set of features; training a final machine learning model which takes as input the final set of features; and using the final machine learning model, generating output based on input values for the final set of features.
2. A method comprising: training a plurality of candidate models based on a plurality of feature groups split from a first set of features, wherein each candidate model in the plurality of candidate models takes as input a feature group from the plurality of feature groups, wherein each feature group includes no more than a first threshold number of features; for each candidate model in the plurality of candidate models: processing the candidate model to extract an explainability vector, wherein each entry in the explainability vector corresponds to a feature in the feature group associated with the candidate model and is indicative of a correlation between the feature and output of the candidate model; based on the explainability vector, selecting a second threshold number of features from the feature group to generate a slim feature group; training a slim candidate model, wherein the slim candidate model takes as input the slim feature group; generating a second set of features by combining features from a plurality of slim candidate models corresponding to the plurality of candidate models; training a final candidate model which takes as input the second set of features; processing the final candidate model to extract a final explainability vector; based on the final explainability vector, selecting a third threshold number of features from the second set of features to generate a final set of features; and training a final machine learning model which takes as input the final set of features.
3. The method of any one of the preceding embodiments, further comprising: training each candidate model in the plurality of candidate models on a unique portion of a training dataset to predict resource consumption; and training the final machine learning model using the training dataset to predict resource consumption.
4. The method of any one of the preceding embodiments, wherein updating a candidate model in plurality of candidate models using an explainability vector further comprises: receiving a user request specifying that a subset of features be removed from consideration or that impact of the subset of features be reduced; and applying a mathematical transformation to the explainability vector such that values corresponding to the subset of features are adjusted.
5. The method of any one of the preceding embodiments, further comprising: calculating a threshold value for removing features; adding features with values the explainability vector below the threshold value to the subset of features; and generating a slim model by removing the subset of features from the candidate model.
6. The method of any one of the preceding embodiments, further comprising: using the final machine learning model, generating output based on input values for the final set of features.
7. The method of any one of the preceding embodiments, wherein: each candidate model in the plurality of candidate models is defined by a set of parameters comprising a matrix of weights for a multivariate regression algorithm; and the explainability vector is extracted from the set of parameters using a Shapley Additive Explanation method.
8. The method of any one of the preceding embodiments, wherein: each candidate model in the plurality of candidate models is defined by a set of parameters comprising a matrix of weights for a supervised classifier algorithm; and the explainability vector is extracted from the set of parameters using a Local Interpretable Model-agnostic Explanations method.
9. The method of any one of the preceding embodiments, wherein: each candidate model in the plurality of candidate models is defined by a set of parameters comprising a vector of coefficients for a generalized additive model; and the explainability vector is extracted from the vector of coefficients in the generalized additive model.
10. The method of any one of the preceding embodiments, wherein: each candidate model in the plurality of candidate models is defined by a set of parameters comprising a matrix of weights for a convolutional neural network algorithm; and the explainability vector is extracted from the set of parameters using a Gradient Class Activation Mapping method.
11. The method of any one of the preceding embodiments, wherein: each candidate model in the plurality of candidate models is defined by a set of parameters comprising a hyperplane matrix for a support vector machine algorithm; and the explainability vector is extracted from the set of parameters using a counterfactual explanation method.
12. The method of any one of the preceding embodiments, comprising performing: for each candidate model in the plurality of candidate models: processing the candidate model to extract an explainability vector; removing a second threshold number of features from the feature group based on the explainability vector to generate a slim feature group; training a slim candidate model, wherein the slim candidate model takes as input the slim feature group; and iteratively repeating the processing, the removing, and the training using the slim candidate model as the candidate model and using the slim feature group as the feature group.
13. The method of any one of the preceding embodiments, comprising: removing a predetermined number of features with lowest values in the explainability vector from the candidate model to generate a preliminary slim model; determining a performance metric of the preliminary slim model and comparing it against a performance benchmark; and in response to the performance metric of the preliminary slim model does not exceed the performance benchmark, repeating the removing and the determining.
14. The method of any one of the preceding embodiments, further comprising: determining that the slim candidate model meets a first performance criterion; and ending the iteratively repeating to select the slim candidate model from the plurality of slim candidate models.
15. One or more tangible, non-transitory, computer-readable media storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for selecting machine learning features using iterative batch feature reduction, comprising:
one or more processors; and
one or more non-transitory, computer-readable media storing instructions that, when executed by the one or more processors, cause operations comprising:
receiving a first set of features for use as input in a machine learning model;
splitting the first set of features into a plurality of feature groups, wherein each feature group includes no more than a first threshold number of features;
training a plurality of candidate models, wherein each candidate model in the plurality of candidate models takes as input a feature group from the plurality of feature groups;
for each candidate model in the plurality of candidate models:
processing the candidate model to extract an explainability vector, wherein each entry in the explainability vector corresponds to a feature in the feature group associated with the candidate model and is indicative of a correlation between the feature and output of the candidate model;
ranking features in the feature group based on the explainability vector;
selecting a second threshold number of features from the ranked feature group to generate a slim feature group;
training a slim candidate model, wherein the slim candidate model takes as input the slim feature group;
generating a second set of features by combining features from a plurality of slim candidate models corresponding to the plurality of candidate models;
training a final candidate model which takes as input the second set of features;
processing the final candidate model to extract a final explainability vector;
ranking features in the second set of features based on the final explainability vector;
selecting a third threshold number of features from the ranked second set of features to generate a final set of features;
training a final machine learning model which takes as input the final set of features; and
using the final machine learning model, generating output based on input values for the final set of features.

2. A method for selecting machine learning features, comprising:
training a plurality of candidate models based on a plurality of feature groups split from a first set of features, wherein each candidate model in the plurality of candidate models takes as input a feature group from the plurality of feature groups, wherein each feature group includes no more than a first threshold number of features;
for each candidate model in the plurality of candidate models:
processing the candidate model to extract an explainability vector, wherein each entry in the explainability vector corresponds to a feature in the feature group associated with the candidate model and is indicative of a correlation between the feature and output of the candidate model;
based on the explainability vector, selecting a second threshold number of features from the feature group to generate a slim feature group;
training a slim candidate model, wherein the slim candidate model takes as input the slim feature group;
generating a second set of features by combining features from a plurality of slim candidate models corresponding to the plurality of candidate models;
training a final candidate model which takes as input the second set of features;
processing the final candidate model to extract a final explainability vector;
based on the final explainability vector, selecting a third threshold number of features from the second set of features to generate a final set of features; and
training a final machine learning model which takes as input the final set of features.

3. The method of claim 2, further comprising:
training each candidate model in the plurality of candidate models on a unique portion of a training dataset to predict resource consumption; and
training the final machine learning model using the training dataset to predict resource consumption.

4. The method of claim 2, wherein updating a candidate model in plurality of candidate models using an explainability vector further comprises:
receiving a user request specifying that a subset of features be removed from consideration or that impact of the subset of features be reduced; and
applying a mathematical transformation to the explainability vector such that values corresponding to the subset of features are adjusted.

5. The method of claim 4, further comprising:
calculating a threshold value for removing features;
adding features with values the explainability vector below the threshold value to the subset of features; and
generating a slim model by removing the subset of features from the candidate model.

6. The method of claim 2, further comprising:
using the final machine learning model, generating output based on input values for the final set of features.

7. The method of claim 2, wherein:
each candidate model in the plurality of candidate models is defined by a set of parameters comprising a matrix of weights for a multivariate regression algorithm; and
the explainability vector is extracted from the set of parameters using a Shapley Additive Explanation method.

8. The method of claim 2, wherein:
each candidate model in the plurality of candidate models is defined by a set of parameters comprising a matrix of weights for a supervised classifier algorithm; and
the explainability vector is extracted from the set of parameters using a Local Interpretable Model-agnostic Explanations method.

9. The method of claim 2, wherein:
each candidate model in the plurality of candidate models is defined by a set of parameters comprising a vector of coefficients for a generalized additive model; and
the explainability vector is extracted from the vector of coefficients in the generalized additive model.

10. The method of claim 2, wherein:
each candidate model in the plurality of candidate models is defined by a set of parameters comprising a matrix of weights for a convolutional neural network algorithm; and
the explainability vector is extracted from the set of parameters using a Gradient Class Activation Mapping method.

11. The method of claim 2, wherein:
each candidate model in the plurality of candidate models is defined by a set of parameters comprising a hyperplane matrix for a support vector machine algorithm; and
the explainability vector is extracted from the set of parameters using a counterfactual explanation method.

12. The method of claim 2, comprising performing:
for each candidate model in the plurality of candidate models:
processing the candidate model to extract an explainability vector;
removing a second threshold number of features from the feature group based on the explainability vector to generate a slim feature group;
training a slim candidate model, wherein the slim candidate model takes as input the slim feature group; and
iteratively repeating the processing, the removing, and the training using the slim candidate model as the candidate model and using the slim feature group as the feature group.

13. The method of claim 12, further comprising:
determining that the slim candidate model meets a first performance criterion; and
ending the iteratively repeating to select the slim candidate model from the plurality of slim candidate models.

14. One or more non-transitory computer-readable media comprising instructions that, when executed by one or more processors, cause operations comprising:
training a plurality of candidate models based on a plurality of feature groups split from a first set of features, wherein each candidate model in the plurality of candidate models takes as input a feature group from the plurality of feature groups;
for each candidate model in the plurality of candidate models:
processing the candidate model to extract an explainability vector;
based on the explainability vector, generating a slim feature group from the feature group;
training a slim candidate model, wherein the slim candidate model takes as input the slim feature group;
generating a second set of features by combining features from a plurality of slim candidate models corresponding to the plurality of candidate models; and
training a final candidate model which takes as input the second set of features;
processing the final candidate model to extract a final explainability vector;
based on the final explainability vector, generating a final set of features from the second set of features; and
training a final machine learning model which takes as input the final set of features.

15. The one or more non-transitory computer-readable media of claim 14, further comprising:
training each candidate model in the plurality of candidate models on a unique portion of a training dataset to predict resource consumption; and
training the final machine learning model using the training dataset to predict resource consumption.

16. The one or more non-transitory computer-readable media of claim 14, wherein updating a candidate model in plurality of candidate models using an explainability vector further comprises:
receiving a user request specifying that a subset of features be removed from consideration or that impact of the subset of features be reduced; and
applying a mathematical transformation to the explainability vector such that values corresponding to the subset of features are adjusted.

17. The one or more non-transitory computer-readable media of claim 16, further comprising:
calculating a threshold value for removing features;
adding features with values the explainability vector below the threshold value to the subset of features; and
generating a slim model by removing the subset of features from the candidate model.

18. The one or more non-transitory computer-readable media of claim 14, wherein updating a candidate model in plurality of candidate models using an explainability vector comprises:
removing a predetermined number of features with lowest values in the explainability vector from the candidate model to generate a preliminary slim model;
determining a performance metric of the preliminary slim model and comparing it against a performance benchmark; and
in response to the performance metric of the preliminary slim model does not exceed the performance benchmark, repeating the removing and the determining.

19. The one or more non-transitory computer-readable media of claim 14, further comprising:
using the final machine learning model, generating output based on input values for the final set of features.

20. The one or more non-transitory computer-readable media of claim 14, wherein:
each candidate model in the plurality of candidate models is defined by a set of parameters comprising a hyperplane matrix for a support vector machine algorithm; and
the explainability vector is extracted from the set of parameters using a counterfactual explanation method.
